(19) United States
(12) Patent Application Publication
(10) Pub. No.: US 2002/0023229 A1
(43) Pub. Date: Feb. 21, 2002

(54) Authentication system

(75) Inventor: Seiichiro Hangai, Tokyo (JP)

Correspondence Address: PAUL A. GUSS, PAUL A. GUSS ATTORNEY AT LAW, 775 S 23RD ST FIRST FLOOR SUITE 2, ARLINGTON, VA, 22202

(73) Assignee: Mizoguchi, Fumio c/o Information Media Center, Chiba (JP)

(21) Appl. No.: 09/768,243

(22) Filed: Jan. 25, 2001

(30) Foreign Application Priority Data
Jul. 25, 2000 (JP) 2000-223748

(51) Int. Cl. H04L 9/00

(52) U.S. Cl. 713/202

(57) ABSTRACT

An authentication system has a direction measuring unit which measures, in a time domain, the direction vector of a pen with respect to a tablet. First and second vector generating units generate, in a time domain, first and second vectors including, as components thereof, the direction vector of the pen when first and second entities write a predetermined pattern on the tablet with the pen. A DP matching unit performs a DP matching process to match time scales of the first and second vectors in order to minimize an accumulated value of differences between the first and second vectors, the differences including differences between the direction vector included in the first vector and the direction vector included in the second vector. A decision unit determines that the first entity and the second entity are identical to or different from each other based on whether the accumulated value of differences between the first vector and the second vector in the DP matching process less or greater than a predetermined threshold.

### BACKGROUND OF THE INVENTION

1. Field of the Invention

The present invention relates to an authentication system, and more particularly to an authentication system which uses, for authentication, individual differences that appear in the directions of pens that entities use to produce writings.

2. Description of the Related Art

As a growing number of consumers access the Internet in recent years, they carry out more commercial transactions via network communications than ever. In view of an increased number of commercial transactions, it is necessary to authenticate individual entities for the safety of commercial dealings. According to a general authentication process, an authentication office assigns passwords or ID numbers required for transactions to respective entities, and asks an entity to enter the assigned password or ID number into a terminal device that is connected for communication with the network, for thereby authenticating the entity. However, if the password or ID number assigned to an entity is known to another entity and the other entity enters the password or ID number into a terminal device, then the authentication office is unable to identify the other entity who has entered the password or ID number.

Because of the above drawback of the conventional authentication system, there have been made in recent years research efforts for studying authentication processes based on biometrics. The authentication processes based on biometrics include processes that use bodily and physical features including DNA, face, retina, fingerprint, etc., and processes that use features about human actions including signature, voice, etc. The former processes are advantageous in that they can make highly reliable authentication because it is extremely difficult for a person to use bodily features such as fingerprint of another person to impersonate the other person. However, the former processes cannot easily be reduce to practice as they require highly expensive special apparatus for DNA, face, or fingerprint identification. One proposed example of the latter processes is based on a handwriting match. Since a handwriting matching process can be performed by an apparatus simpler than apparatus for DNA, face, or fingerprint identification, it is much easier to construct a system based on the handwriting matching process. However, the reliability of authentication made by the handwriting matching system is not good enough because the handwriting of a person can highly possibly be imitated by another person.

The inventor of the present invention has paid attention to individual differences that appear in the directions of pens that entities use to produce writings, and proposed an authentication process that is highly reliable and practical based on such individual differences (see The Journal of the Institute of Electronics, Information, and Communication Engineers, “On-line signature matching based on the direction of a pen upon signature”, published February 1998). According to the proposed authentication process, time-dependent changes in the direction of a pen used by a person in question with respect to a surface on which the person writes a signature are measured, and registered as reference signature data. Then, time-dependent changes in the direction of a pen used by a certain person when a similar signature is made by that person are measured as signature data to be authenticated, and compared with the reference signature data. Time scales of both the measured data are matched when the measured data are to be compared with each other. For example, if the ratio of the measuring time of the reference signature data to the measuring time of the signature data to be authenticated is 1.1:1, then the time scale of the latter signature data is uniformly enlarged 1.1 times to match the time scale of the reference signature data. After the time scales of both the signature data have been matched, both the signature data are compared with each other. If the difference or error between the compared signal data is equal to or less than a predetermined threshold, then the person who produced the signature data to be authenticated is judged as the person in question. If the difference or error is greater than the predetermined threshold, then the person who produced the signature data to be authenticated is judged as another person. The proposed authentication process is much improved over the authentication process which uses handwritings only.

However, even through the time scales of signature data to be compared with each other are matched, there is a possibility that the person in question may be recognized as another person due to partial variations of the writing time. For example, it is assumed that a signature is written in two divided patterns, and when reference signature data is measured, the ratio of the writing time of the former pattern to the writing time of the latter pattern is 0.45:0.55, and when signature data to be authenticated is measured, the ratio of the writing time of the former pattern to the writing time of the latter pattern is 0.55:0.45, and also that the direction of the pen used changes distinctly between the former and latter patterns. In this case, the difference or error between both the signature data is large in a time zone ranging from 0.45 to 0.55, and as a result the person in question may be judged in error as another person even though the reference signature data and the signature data to be authenticated are produced by the same person.

### SUMMARY OF THE INVENTION

It is therefore an object of the present invention to provide an authentication system which is made more reliable by eliminating the effect of partial variations of writing time and comparing time-dependent changes in the direction of a pen.

To achieve the above object, there is provided in accordance with the present invention an authentication system comprising direction measuring means for measuring, in a time domain, the direction vector of a pen represented by a tilt angle or direction angle of the pen with respect to a writing surface, first vector generating means for generating, in a time domain, a first vector including, as a component thereof, the direction vector of the pen measured by the direction measuring means when a first entity writes a predetermined pattern on the writing surface with the pen, second vector generating means for generating, in a time domain, a second vector including, as a component thereof, the direction vector of the pen measured by the direction measuring means when a second entity writes the predetermined pattern on the writing surface with the pen, DP matching means for performing a DP matching process to match time scales of the first and second vectors in order to minimize an accumulated value of differences between the first vector generated by the first vector generating means and the second vector generated by the second vector generating means, the differences including differences between the direction vector included in the first vector and the direction vector included in the second vector, and decision means for determining that the first entity and the second entity are identical to each other if the accumulated value of differences between the first vector and the second vector in the DP matching process performed by the DP matching means is equal to or less than a predetermined threshold, and determining that the first entity and the second entity are different from each other if the accumulated value is greater than the predetermined threshold.

When the first entity writes the predetermined pattern on the writing surface with the pen, the direction measuring means measures, in a time domain, the direction vector of the pen represented by a tilt angle or direction angle of the pen with respect to the writing surface. The first vector generating means generates, in a time domain, a first vector including, as a component thereof, the direction vector of the pen measured by the direction measuring means. When the second entity writes the predetermined pattern on the writing surface with the pen, the direction measuring means measures, in a time domain, the direction vector of the pen, and the second vector generating means generates, in a time domain, a second vector including, as a component thereof, the direction vector of the pen measured by the direction measuring means. The writing surface may comprise a flat surface or a curved surface which may be part of a spherical surface. The predetermined pattern means any pattern which can be written or drawn on the writing surface with the pen, and may be a character, a symbol, a sign, a figure, a combination thereof, or a fraction thereof.

The DP matching means performs a DP matching process to adjust time scales of the first and second vectors in order to minimize an accumulated value of differences between the first vector and the second vector, i.e., to best match the first vector and the second vector. The differences between the first vector and the second vector include differences between the direction vector included in the first vector and the direction vector included in the second vector. The differences between the vectors include an angle between the vectors, a distance between points in a vector space which are represented by the vectors, an inner product of the vectors, and the difference between the lengths of the vectors.

The DP matching process will briefly be described below with reference to FIGS. 2(a) and 2(b) of the accompanying drawings. For the sake of brevity, it is assumed that the first and second vectors are a one-dimensional vector, and, as indicated by the dotted-line curve in FIG. 2(a), the first vector increases from a time 0 a time t₁, decreases from the time t₁ to a time t₂, and increases from the time t₂ to a time t₃, and as indicated by the solid-line curve in FIG. 2(a), the second vector increases from the time 0 to a time t₁′, decreases from the time t₁′ to a time t₂′ and increases from the time t₂′ to a time t₃′. It is also assumed that the times are related such that t₁′<t₁<t₂′<t₂<t₃<t₃′, the ratio of the periods between the times 0 and t₁, t₁ and t₂, t₂ and t₃ is 2:2:1, the ratio of the periods between the times 0 and t₁′, t₁′ and t₂′, t₂′ and t₃′ is 1:2:3, and the time-dependent changes of the vectors have partial variations. When the DP matching process is performed, the periods between the times 0 and t₁′, t₁′ and t₂′, t₂′ and t₃′ of the second vector are expanded, as indicated by the solid-line curve in FIG. 2(b), to match the periods between the times 0 and t₁, t₁ and t₂, t₂ and t₃ of the first vector indicated by the dotted-line curve in FIG. 2(b). If the time scale of the second vector is uniformly reduced, as indicated by the dot-and-dash-line curve in FIG. 2(b), to match the time scale of the first vector, as is conventional, then the vectors are made greatly different from each other, reflecting the partial variations of the time scales.

Finally, the decision means determines that the first entity and the second entity are identical to each other if the accumulated value of differences between the first vector and the second vector in the DP matching process performed by the DP matching means is equal to or smaller than a predetermined threshold, and determines that the first entity and the second entity are different from each other if the accumulated value is greater than the predetermined threshold.

With the above authentication system, the partial variations of the time-dependent changes of the vectors are eliminated by the DP matching process, allowing the vectors to best match each other. Based on the accumulated value of differences between the vectors, it is determined whether the first entity and the second entity are identical to each other or not. Since the partial variations of the time-dependent changes of the vectors are eliminated, the first and second entities who are identical to each other are prevented from being judged as different from each other due to time-dependent partial variations in the direction of the pen that occur when the pattern is written on the writing surface.

The differences between the first vector and the second vector in the DP matching process include differences between the direction vector included in the first vector and the direction vector included in the second vector. The direction vector of the pen represents the direction of the pen with respect to the writing surface when each of the entities writes the predetermined pattern on the writing surface. The differences between the vectors are represented by the inner product of the vectors, the angle between the vectors, the distance between the vectors, etc. Therefore, the differences between the first vector and the second vector include deviations of the direction vector of the pen at the time the first and second entities write the predetermined pattern on the writing surface. Consequently, an authentication process can be performed by directly reflecting an individuals' difference appearing in the direction vector of the pen in the differences between the first and second vectors.

Preferably, the authentication system further has pen tip position measuring means for measuring, in a time domain, the position vector of the tip of the pen on the writing surface, or writing pressure measuring means for measuring, in a time domain, the writing pressure applied to the writing surface by the pen. The first and second vector generating means comprises means for generating, in a time domain, first and second vectors, respectively, which include, as a component thereof, the position vector measured by the pen tip position measuring means or the writing pressure measured by the writing pressure measuring means. The DP matching means comprises means for determining the differences between the first and second vectors by standardizing the differences between the direction vector included in the first vector and the direction vector included in the second vector and differences between the position vector or writing pressure included in the first vector and the position vector or writing pressure included in the second vector, weighting the standardized differences, and adding the weighted differences when the DP matching process is performed on the first and second vectors by the DP matching means.

In the above authentication system, the first and second vectors include, as their components, the direction vector of the pen and the position vector of the tip of the pen on the writing surface or the writing pressure applied to the writing surface by the pen. In the DP matching process, the differences between the first and second vectors are determined by standardizing the differences between the direction vector included in the first vector and the direction vector included in the second vector and differences between the position vector or writing pressure included in the first vector and the position vector or writing pressure included in the second vector, weighting the standardized differences, and adding the weighted differences. The term “standardize” used herein means a process of making the units of vectors dimensionless in order to be able to evaluate the differences between components of vectors of different unit dimensions, and converting the magnitudes of the vectors into numerical values in a common range of [0, 1], for example. Since the differences between the first vector and the second vector include differences between the direction vectors, the position vectors, and the writing pressures as components of the first and second vectors. Therefore, the authentication process can be carried out by comparing the writing habits of the entities based on the direction of the pen with respect to the writing surface, the position of the tip of the pen on the writing surface, and the writing pressure applied to the writing surface by the pen.

The inventor has found that the writing habit of each entity tends to appear better in the position vector than in the writing pressure and better in the direction vector than in the position vector. Therefore, if the standardized differences between the direction vectors are weighted to an extent greater than the standardized differences between the position vectors are weighted, and standardized differences between the position vectors are weighted to an extent greater than the standardized differences between the writing pressures, then the differences between the first and second vectors appropriately reflect the writing habit of each entity.

Preferably, therefore, the DP matching means comprises means for determining the differences between the first and second vectors by standardizing the differences between the direction vector included in the first vector and the direction vector included in the second vector and the differences between the position vector or writing pressure included in the first vector and the position vector or writing pressure included in the second vector, weighting the standardized differences such that the former differences are weighted to an extent greater than the latter differences, and adding the weighted differences when the DP matching process is performed on the first and second vectors by the DP matching means.

The authentication system may further comprise pen tip position measuring means for measuring, in a time domain, the position vector of the tip of the pen on the writing surface, and writing pressure measuring means for measuring, in a time domain, the writing pressure applied to the writing surface by the pen, the first vector generating means and the second vector generating means comprising means for generating, in a time domain, first and second vectors, respectively, which include the position vector and the writing pressure as components thereof, and the DP matching means comprising means for determining the differences between the first and second vectors by standardizing the differences between the position vector included in the first vector and the position vector included in the second vector and the differences between the writing pressure included in the first vector and the writing pressure included in the second vector, weighting the standardized differences such that the former differences are weighted to an extent greater than the latter differences, and adding the weighted differences when the DP matching process is performed on the first and second vectors by the DP matching means.

According to the above weighting process, the standardized differences between the direction vectors are weighted to an extent greater than the standardized differences between the position vectors are weighted, and standardized differences between the position vectors are weighted to an extent greater than the standardized differences between the writing pressures. By performing the authentication process based on these differences, the reliability of the authentication system is further increased.

Preferably, the first vector generating means comprises means for generating, in a time domain, a plurality of sets of the first vector when the first entity writes the predetermined pattern on the writing surface a plurality of times, the DP matching means comprising means for performing the DP matching process on the plurality of sets of the first vector, and the first vector generating means comprising means for generating, in a time domain, an average vector of the plurality of sets of the first vector processed by the DP matching process as a new first vector.

Preferably, the second vector generating means comprises means for generating, in a time domain, a plurality of sets of the second vector when the second entity writes the predetermined pattern on the writing surface a plurality of times, the DP matching means comprising means for performing the DP matching process on the plurality of sets of the second vector, and the second vector generating means comprising means for generating, in a time domain, an average vector of the plurality of sets of the second vector processed by the DP matching process as a new second vector.

In the above authentication system, the plurality of sets of first and second vectors processed by the DP matching process are averaged. Therefore, the first and second vectors are prevented from reflecting accidental writing habits as writing habits peculiar to the entities. Specifically, even if a set of first and second vectors reflect an accidental writing habit, it is highly likely that another set of first and second vectors do not reflect that accidental writing habit. Therefore, the adverse effect of an accidental writing habit is reduced by averaging the plurality of sets of first and second vectors processed by the DP matching process. Furthermore, the first and second vectors are also prevented from not reflecting writing habits that do not appear accidentally as no writing habits peculiar to the entities. Specifically, even if a set of first and second vectors do not reflect a peculiar writing habit, it is highly likely that another set of first and second vectors reflect that peculiar writing habit. Therefore, the writing habit can clearly be indicated by averaging the plurality of sets of first and second vectors processed by the DP matching process. When the entities are identified as being identical to or different from each other based on the first and second vectors that are less subject to the effect of an accidental writing habit and clearly represent a peculiar writing habit, the reliability of the authentication process is increased.

Preferably, the threshold is substantially the same as a maximum value of the accumulated value of the differences in the DP matching process performed on the plurality of sets of the first vector. The accumulated value of differences represents how much the writing habit varies when the same first entity writes the same predetermined pattern. Specifically, when the second entity who is the same as the first entity writes the same predetermined pattern for authentication, it is expected that the accumulated value of differences remains the same due to variations of the writing habit. Since the authentication process is carried out on the assumption that the writing habit varies, the possibility that the entities who are identical to each other are erroneously judged as different from each other is lowered. Moreover, the threshold may be increased for the first entity whose writing habit tends to vary to a large extent for thereby making authenticating conditions less strict, and the threshold may be decreased for the first entity whose writing habit tends to vary to a small extent for thereby keeping the overall authentication system reliable.

The above and other objects, features, and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a block diagram of an authentication system according to the present invention;

FIGS. 2(a) and 2(b) are diagrams illustrative of a DP matching process performed by the authentication system according to the present invention; and

FIGS. 3(a) through 3(c) are diagrams illustrative of details of the DP matching process performed by the authentication system according to the present invention.

### DETAILED DESCRIPTION OF THE PREFERRED EMBODIMENT

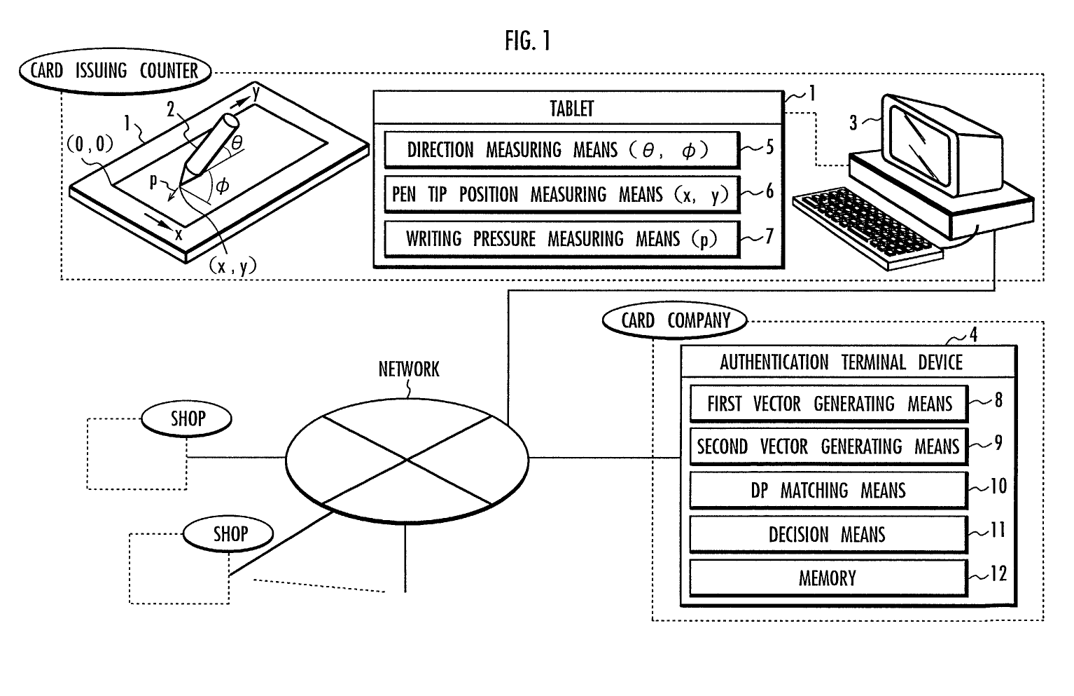

As shown in FIG. 1, an authentication system according to the present invention generally comprises a plurality of substantially flat tablets (writing surfaces) 1 (only one shown) placed in respective locations, a plurality of pen 2 (only one shown) each with a magnet (not shown) incorporated therein, a plurality of terminal devices 3 (only one shown) connected to the respective tablets 1, and an authentication terminal device 4 connected to the terminal devices 3 via a network for communication with the terminal devices 3. Since the sets of the tablets 1, the pens 2, and the terminal devices 3 are identical to each other, only one set of the tablet 1, the pen 2, and the terminal device 3 will be described in detail below.

The tablet 1 has a direction measuring means 5 for measuring, in a time domain, a direction vector a=^{t}(cosθsinφ, cosθsinφ, sinθ) of the pen 2 which is represented by an tilt angle θ and a direction angle θ of the pen 2 with respect to the tablet 1 by detecting the magnetic force of the magnet incorporated in the pen 2, a pen tip position measuring means 6 for measuring, in a time domain, a position vector b×(x, y) of the tip of the pen 2 on the tablet 1, and a writing pressure measuring means 7 for measuring, in a time domain, a writing pressure p applied from the tip of the pen 2 to the tablet 1.

The authentication terminal device 4 comprises a first vector generating means 8 for generating a first vector used as an authentication reference, a second vector generating means 9 for generating a second vector to be compared with the first vector for authentication, a DP (Dynamic Programming) matching means 10 for performing DP matching between the first and second vectors, a decision means 11 for determining whether a person who has produced a signature is a person in question or not, and a memory 12 for storing various data required for authentication. Each of the first vector ^{t}(a₁, b₁, p₁) generated by the first vector generating means 8 and the second vector ^{t}(a₂, b₂, p₂) generated by the second vector generating means 9 is a six-dimensional vector including a three-dimensional direction vector a₁ or a₂, a two-dimensional position vector b₁ or b₂, and a writing pressure p₁ or p₂.

An authentication process carried out by the authentication system shown in FIG. 1 will be described below. In the illustrated embodiment, the authentication system is applied to a shopping practice based on credit cards. The tablet 1, the pen 2, and the terminal device 3 are located in each of card issuing counters and shops, and the authentication terminal device 4 is owned by a card company. A first entity desiring to have a card enters individual data required for the issuance of the card into the terminal device 3 at a card issuing counter. The first entity uses the pen 2 to write its own name, i.e., a predetermined pattern, on the tablet 1 connected to the terminal device 3. At this time, the direction measuring means 5, the pen tip position measuring means 6, and the writing pressure measuring means 7 measure, in a time domain, a direction vector, a position vector, and a writing pressure, respectively, of the pen 2. The measured direction vector, position vector, and writing pressure are used as reference signature data. The time when the writing pressure increases from “0” to a finite value is measured as a writing start time, and the time when the writing pressure decreases finally to “0” is measured as a writing end time. Then, the individual data and the reference signal data are transmitted from the terminal device 3 at the card issuing counter to the authentication terminal device 4. When the card company issues a card, the reference signature data together with card data such as the password are stored in the memory 12.

In a shop equipped with the tablet 1, the pen 2, and the terminal device 3, a second entity who wants to purchase merchandise using a card issued by the card company enters the card data into the terminal device 3 and write a signature on the tablet 1 with the pen 2. At this time, the direction measuring means 5, the pen tip position measuring means 6, and the writing pressure measuring means 7 measure, in a time domain, a direction vector, a position vector, and a writing pressure, respectively, of the pen 2. The measured direction vector, position vector, and writing pressure are used as signature data to be authenticated. The card data and the signature data to be authenticated are then transmitted from the terminal device 3 at the shop to the authentication terminal device 4.

In the authentication terminal device 4, the first vector generating means 8 generates a first vector according to the card data that is transmitted from the terminal device 3 at the shop based on the reference signature data stored in the memory 12. The second vector generating means 9 generates a second vector based on the signature data to be authenticated that is transmitted from the terminal device 3 at the shop.

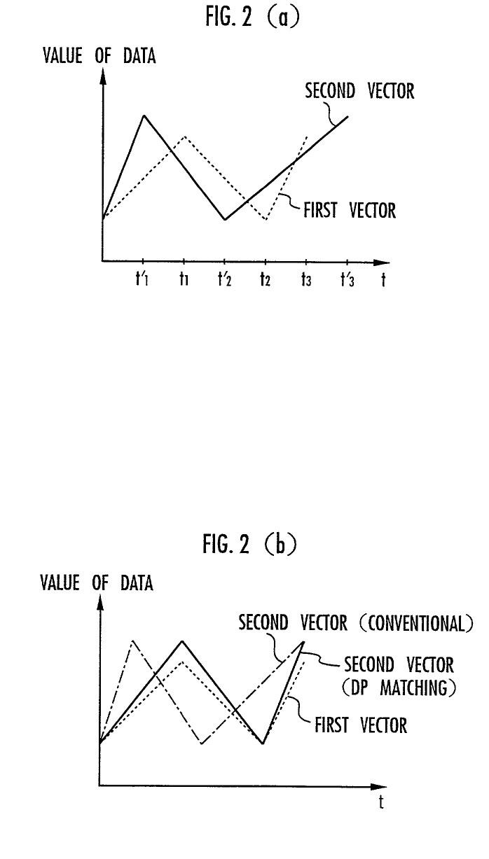

The DP matching means 10 effects a DP matching process on the first and second vectors. According to the DP matching process, the time scales of the first and second vectors are adjusted to minimize the accumulated value of differences between the first and second vectors as briefly described above with reference to FIG. 2. Details of such adjustment of the time scales of the first and second vectors will be described later on. The difference d between the first and second vectors is expressed by the following equation (1):

d=αf(|arccos(a₁·a₂)|) +βf(|b₁−b₂|)+γf(|p₁−p₂|) (1)

where the function f(X)=(X−minX)/(maxX−minX) is a function to make the difference X dimensionless and standardize the difference X in a range of [0, 1]. On the right side of the equation (1), the first term represents an angle between the direction vectors a₁, a₂ of the pen 2, the second term the distance between the position vectors b₁, b₂ of the pen 2, the third term the difference between the writing pressures p₁, p₂ of the tip of the pen 2, and α, β, γ are weights determined depending on which of the direction of the pen 2 and the position and pressure of the tip of the pen 2 the writing habit of each entity appears most in, the weights α, β, γ having their magnitudes related by α>β>γ.

Finally, the accumulated value of the differences between the first and second vectors in the DP matching process is compared with a threshold. If the accumulated value is equal to or less than the threshold, then the first and second entities are the same as each other. That is, the person who produced the signature in the shop is judged as the card owner. If the accumulated value is greater than the threshold, then the first and second entities are different from each other. That is, the person who produced the signature in the shop is judged as a person different from the card owner. The determined result is transmitted from the authentication terminal device 4 to the terminal device 3 at the shop. If the person who produced the signature in the shop is judged as the card owner, then the shopping goes on, and if the person who produced the signature in the shop is judged as different from the card owner, then the shopping stops.

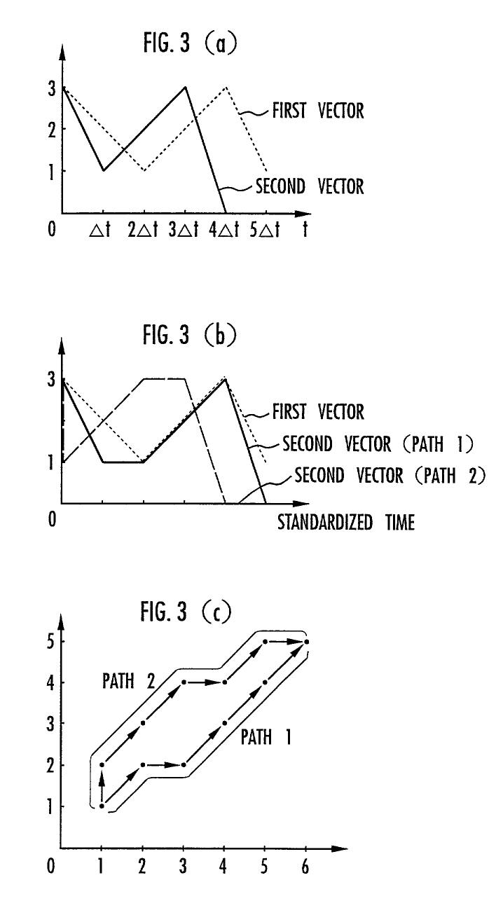

Details of the DP matching process will be described below with reference to FIGS. 3(a) through 3(c). Though the first and second vectors are a six-dimensional vector as described above, they will be described as a one-dimensional vector below for the sake of brevity. It is assumed that the first vector generating means 8 generates a set of n₁=6 first vectors (3, 2, 1, 2, 3, 1) that change in each time interval Δt as indicated by the dotted-line curve in FIG. 3(a), and the second vector generating means 9 generates a set of n₂=5 second vectors (3, 1, 2, 3, 0) that change in each time interval Δt as indicated by the solid-line curve in FIG. 3(a).

The DP matching process employs a grid system shown in FIG. 3(c) in which an m₁th first vector and an m₂th second vector correspond to a grid point (m₁, m₂). For example, a 1st first vector (=3) and a 3rd second vector (=2) correspond to a grid point (1, 3). Grid points from (1, 1) to (n₁=6, n₂=5) are connected in order to minimize the accumulated value of differences (see the equation (1)) above between the first and second vectors corresponding to the grid points. For example, if it is assumed that the difference represents the absolute value of the difference between the first and second vectors, then the difference between the first and second vectors at the grid point (1, 1) is 0 represented by the absolute value of the difference between the 1st first vector (=3) and the 1st second vector (=3). At this time, a grid point (m₁, m₂) is connected to a grid point (m₁+1, m₂), (m₁, m₂+1), or (m₁+1, m₂+1). For example, a grid point (1, 1) is connected to a grid point (1, 2), (2, 1), or (2, 2).

Now, a path 1 {(1, 1) → (2, 2) → (3, 2) → (4, 3) → (5, 4) → (6, 5)} and a path 2 {(1, 1) → (1, 2) (2, 3) → (3, 4) → (4, 4) → (5, 5) → (6, 5)} will be considered below. The accumulated value of the differences between the first and second vectors that correspond to the grid point is 2 for the path 1 and 9 for the path 2. The time scales of the first and second vectors are matched such that with respect to the path 1 passing through the grid point (3, 2), for example, the time 2Δt of the 3rd first vector corresponds to the time Δt of the 2nd second vector. The result shown in FIG. 3(b) indicates that the first and second vectors match each other better according to the path 1 where the accumulated values of the differences is small than according to the path 2 where the accumulated values of the differences is large. It is thus clearly seen that the matching of the first and second vectors is best if the time scales thereof are matched according the path where the accumulated values of the differences is minimum.

In the authentication system according to the present embodiment, the time scales of the first and second vectors are adjusted to cause the first and second vectors to match each other best according to the DP matching process. It is determined whether the first entity who is the authentic card owner and the second entity who attempts to do the shopping using the card are the same as each other or not based on the accumulated value of the differences between the first and second vectors. In this manner, since partial variations of time-dependent changes of the first and second vectors are eliminated, the second entity, who is actually identical to the first entity, is prevented from being judged as different from the first entity due to partial variations of time-dependent changes of the pen 2 used to write a signature.

As indicated by the equation (1), the difference d between the first and second vectors includes the angle formed between the direction vectors a₁, a₂, the distance between the position vectors b₁, b₂, and the difference between the writing pressures p₁, p₂. Therefore, it is possible to authenticate the signature by comparing the writing habits of the first and second entities based on the direction of the pen 2 with respect to the tablet 1, the position of the tip of the pen 2 on the tablet 1, and the writing pressure applied from the pen 2 to the tablet 1.

An experiment conducted on a plurality of persons by the inventor indicates that if the weights used in the equation (1) are α=0.49>β=0.34>γ=0.17 under the condition of α+β+γ=1, then the probability that the person is judged as authentic was a high value of 98.2% on the average. The magnitude relationship of α>β>γ means that the writing habit of each of the entities appears better in the position vector than in the writing pressure and also better in the direction vector than in the position vector. Therefore, the reliability of the authentication system is increased if a signature is authenticated based on the difference d between the first and second vectors determined from the magnitude relationship of α>β>γ.

As is clear from the magnitude relationship of α>β>γ, the angle formed between the direction vectors a₁, a₂ of the pen 2 which are produced when the first and second entities make signatures using the pen 2 is considered most important for authentication. For example, the difference between a right-handed entity and a left-handed entity is clearly distinguished because the direction vectors of the pen 2 used by them to producing writings are distinctly different from each other. Furthermore, since the direction vector of the pen 2 used by an entity who produces a writing with the hand kept out of touch with the tablet 1 tends to be substantially vertical to the tablet 1 compared with an entity who produces a writing with the hand kept in touch with the tablet 1, such a tendency can be used to perform an authenticating process.

In the illustrated embodiment, the authentication system is applied to a shopping practice using a card. However, the principles of the present invention are also applicable to events requiring authentication, such as a withdrawal from the deposit in a bank account, for example.

In the illustrated embodiment, the predetermined pattern written on the tablet 1 is the name of the entity. However, the predetermined pattern written on the tablet 1 may be a character, a symbol, a sign, a figure, a combination thereof, or a fraction thereof. Particularly, when a fraction of a character or the like is used as the predetermined pattern and when different characters are written on the tablet 1, if those different characters include a common pattern, then since it allows the authentication process to be carried out, the versatility of the authentication system increases. For example, it is assumed that the first entity writes a symbol “Δ” counterclockwise and the second entity writes a symbol “□” counterclockwise. The bottom side of the former symbol and the lower side of the latter symbol represent a rightward common pattern on the tablet, which shows the entities' habit when they move the tip of the pen to the right. By comparing the first and second vectors corresponding to the direction of the pen 2 when this common pattern is written on the tablet 1, the authentication process is performed more reliably. The time in which the rightward pattern is written is measured based on time-dependent changes in the position vector measured by the pen tip position measuring means 6, rather than on time-dependent changes in the writing pressure measured by the writing pressure measuring means 7. If the positive direction x on the tablet 1 is a rightward direction, then it is measured that the predetermined pattern is written for a time in which dx/dt>0, dy/dt=0.

In the above embodiment, the first and second vectors are a six-dimensional vector. However, the first and second vectors may be a vector of a less dimension, e.g., a three-, four-, or fifth-dimensional vector, leaving the direction vector of the pen 2. In such a modification, since the accumulated value of differences between the first and second vectors in the DP matching process reflects an individuals' difference that appears in the direction of the pen 2 when the entities write signatures on the tablet 1, a highly reliable authentication process can be carried out using the individuals' difference.

In the above embodiment, the weights in the equation (1) are related as α>β>γ>. However, the weights in the equation (1) may be related otherwise such as α<β<γ, α=β=γ, etc. In such modifications, the equation (1) representing the difference d between the first and second vectors reflects the angle between the direction vectors a₁, a₂ of the pen 2 as indicated by the first term on the right side of the equation (1). Therefore, the authentication process can be carried out in a manner to reflect the writing habits of the entities that appear in the direction vector of the pen 2.

In the above embodiment, the entities write a signature once for the issuance of a card and once for shopping with the card. However, the entities may write a signature a plurality of times in any of these events, the first vector generating means 8 and the second vector generating means 9 may generate a plurality of sets of first and second vectors from a plurality of signature data, the DP matching means 10 may perform a DP matching process on the plurality of sets of first and second vectors, and the first vector generating means 8 and the second vector generating means 9 may generate average vectors of the plurality of sets of first and second vectors processed by the DP matching process, as new first and second vectors.

In such a modification, the plurality of sets of first and second vectors processed by the DP matching process are averaged. Therefore, the first and second vectors are prevented from reflecting accidental writing habits as writing habits peculiar to the entities. Specifically, even if a set of first and second vectors reflect an accidental writing habit, it is highly likely that another set of first and second vectors do not reflect that accidental writing habit. Therefore, the adverse effect of an accidental writing habit is reduced by averaging the plurality of sets of first and second vectors processed by the DP matching process. Furthermore, the first and second vectors are also prevented from not reflecting writing habits that do not appear accidentally as no writing habits peculiar to the entities. Specifically, even if a set of first and second vectors do not reflect a peculiar writing habit, it is highly likely that another set of first and second vectors reflect that peculiar writing habit. Therefore, the writing habit can clearly be indicated by averaging the plurality of sets of first and second vectors processed by the DP matching process. When the entities are identified as being identical to or different from each other based on the first and second vectors that are less subject to the effect of an accidental writing habit and clearly represent a peculiar writing habit, the reliability of the authentication process is increased.

For performing the DP matching process on a plurality of sets of first vectors, a threshold may be established which is substantially the same as a maximum value of the accumulated value of differences in the DP matching process. The accumulated value of differences represents how much the writing habit varies when the same first entity writes the same predetermined pattern. Specifically, when the second entity who is the same as the first entity writes the same predetermined pattern for authentication, it is expected that the accumulated value of differences remains the same due to variations of the writing habit. Since the authentication process is carried out on the assumption that the writing habit varies, the possibility that the entities who are identical to each other are erroneously judged as different from each other is lowered. Moreover, the threshold may be increased for the first entity whose writing habit tends to vary to a large extent for thereby making authenticating conditions less strict, and the threshold may be decreased for the first entity whose writing habit tends to vary to a small extent for thereby keeping the overall authentication system reliable.

Although a certain preferred embodiment of the present invention has been shown and described in detail, it should be understood that various changes and modifications may be made therein without departing from the scope of the appended claims.

What is claimed is:

1. An authentication system comprising:
direction measuring means for measuring, in a time domain, the direction vector of a pen represented by a tilt angle or direction angle of the pen with respect to a writing surface;
first vector generating means for generating, in a time domain, a first vector including, as a component thereof, the direction vector of the pen measured by said direction measuring means when a first entity writes a predetermined pattern on the writing surface with the pen;
second vector generating means for generating, in a time domain, a second vector including, as a component thereof, the direction vector of the pen measured by said direction measuring means when a second entity writes said predetermined pattern on the writing surface with the pen;
DP matching means for performing a DP matching process to match time scales of the first and second vectors in order to minimize an accumulated value of differences between the first vector generated by said first vector generating means and the second vector generated by said second vector generating means, said differences including differences between the direction vector included in said first vector and the direction vector included in said second vector; and
decision means for determining that said first entity and said second entity are identical to each other if the accumulated value of differences between the first vector and the second vector in said DP matching process performed by said DP matching means is equal to or smaller than a predetermined threshold, and determining that said first entity and said second entity are different from each other if said accumulated value is greater than said predetermined threshold.

2. An authentication system according to claim 1, further comprising:
pen tip position measuring means for measuring, in a time domain, the position vector of the tip of said pen on said writing surface, or writing pressure measuring means for measuring, in a time domain, the writing pressure applied to said writing surface by said pen;
said first and second vector generating means comprising means for generating, in a time domain, first and second vectors, respectively, which include, as a component thereof, the position vector measured by said pen tip position measuring means or the writing pressure measured by said writing pressure measuring means;
said DP matching means comprising means for determining said differences between said first and second vectors by standardizing the differences between the direction vector included in said first vector and the direction vector included in said second vector and differences between the position vector or writing pressure included in said first vector and the position vector or writing pressure included in said second vector, weighting the standardized differences, and adding the weighted differences when the DP matching process is performed on said first and second vectors by said DP matching means.

3. An authentication system according to claim 2, wherein said DP matching means comprises means for determining said differences between said first and second vectors by standardizing the differences between the direction vector included in said first vector and the direction vector included in said second vector and the differences between the position vector or writing pressure included in said first vector and the position vector or writing pressure included in said second vector, weighting the standardized differences such that the former differences are weighted to an extent greater than the latter differences, and adding the weighted differences when the DP matching process is performed on said first and second vectors by said DP matching means.

4. An authentication system according to claim 1, further comprising:
pen tip position measuring means for measuring, in a time domain, the position vector of the tip of said pen on said writing surface; and
writing pressure measuring means for measuring, in a time domain, the writing pressure applied to said writing surface by said pen;
said first vector generating means and said second vector generating means comprising means for generating, in a time domain, first and second vectors, respectively, which include said position vector and said writing pressure as components thereof;
said DP matching means comprising means for determining said differences between said first and second vectors by standardizing the differences between the position vector included in said first vector and the position vector included in said second vector and the differences between the writing pressure included in said first vector and the writing pressure included in said second vector, weighting the standardized differences such that the former differences are weighted to an extent greater than the latter differences, and adding the weighted differences when the DP matching process is performed on said first and second vectors by said DP matching means.

5. An authentication system according to any one of claims 1 through 4, wherein said first vector generating means comprises means for generating, in a time domain, a plurality of sets of the first vector when said first entity writes said predetermined pattern on said writing surface a plurality of times, said DP matching means comprising means for performing the DP matching process on said plurality of sets of the first vector, and said first vector generating means comprising means for generating, in a time domain, an average vector of the plurality of sets of the first vector processed by the DP matching process as a new first vector.

6. An authentication system according to claim 5, wherein said threshold is substantially the same as a maximum value of the accumulated value of the differences in the DP matching process performed on the plurality of sets of the first vector.

7. An authentication system according to claim 1, 2, 3, 4 or 6 wherein said second vector generating means comprises means for generating, in a time domain, a plurality of sets of the second vector when said second entity writes said predetermined pattern on said writing surface a plurality of times, said DP matching means comprising means for performing the DP matching process on said plurality of sets of the second vector, and said second vector generating means comprising means for generating, in a time domain, an average vector of the plurality of sets of the second vector processed by the DP matching process as a new second vector.

8. An authentication system according to claim 5, wherein said second vector generating means comprises means for generating, in a time domain, a plurality of sets of the second vector when said second entity writes said predetermined pattern on said writing surface a plurality of times, said DP matching means comprising means for performing the DP matching process on said plurality of sets of the second vector, and said second vector generating means comprising means for generating, in a time domain, an average vector of the plurality of sets of the second vector processed by the DP matching process as a new second vector.
